(19) United States
(12) Patent Application Publication
(10) Pub. No.: US 2006/0150831 A1
(43) Pub. Date: Jul. 13, 2006

(54) Apparatus for marinating foods

(76) Inventors: Benita Francis, Coral Springs, FL (US); Derrick Francis, Coral Springs, FL (US); Michael Anthony, Coral Springs, FL (US)

Correspondence Address: Mark D. Bowen;Stearns Weaver Miller, et al., Suite 1900, 200 East Broward Boulevard, Fort Lauderdale, FL, 33301, US

(21) Appl. No.: 11/033,938

(22) Filed: Jan. 12, 2005

(51) Int. Cl. B02C 11/08

(52) U.S. Cl. 99/534

(57) ABSTRACT

An electric food marinating apparatus capable of automatically marinating foods quicker and more effectively than traditional prior art methods by circulating chilled marinade in a closed loop circuit. A removable marinating vessel for containing food is adapted for continuous rotation about a vertical axis. The marinating vessel defines a generally open top and a bottom defining a strainer outlet in communication a marinade reservoir for receiving marinade in a closed loop flow path. An electric motor has an output shaft connected to the marinade reservoir to rotate the marinating vessel. A peristaltic pump housed within the base is configured with an inlet in fluid communication with the marinade reservoir and a spray outlet disposed proximal the top of the rotating marinating vessel. A thermoelectric cooler is provided for cooling the marinade.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to food preparation, and more particularly to an automatic marinating apparatus for marinating food products to induce flavoring agents into food products.

2. Description of Related Art

It is well known in the culinary art to marinate certain foods as a means to enhance flavor and to tenderize certain cuts of meats. Conventional marinating techniques involve placing the food, typically meat, poultry, or fish, in a flavorful marinating liquid for an extended period of time so that the food absorbs the marinade. While the marinating process is old and well known the process usually requires a substantial amount of time so as to allow the food to sufficiently absorb the marinating liquid. For instance, certain marinating processes involve marinating the food for as long as forty-eight hours prior to cooking.

Very often, however, time does not permit such thorough marinating and the quality and flavor is typically less than what it would have been with proper preparation. As time does not always permit such thorough marinating, the quality of the cooked food is often less than what it would have been with proper preparation. Accordingly, there exists a need for an automated device that increases the efficiency of the marinating process by decreasing the time required to marinate foods. The apparatus and process disclosed herein is directed to overcoming the disadvantages in the art to allow for complete marinating of foodstuffs in far less time than heretofore required for the process.

### BRIEF SUMMARY OF THE INVENTION

The present invention provides an electric food marinating apparatus capable of automatically marinating foods quicker and more effectively than traditional prior art methods by circulating chilled marinade in a closed loop circuit. An automatic food marinating apparatus according to the present invention provides a removable marinating vessel for holding the food and adapted for continuous rotation about a vertical axis. The marinating vessel defines a generally open top and a bottom defining a strainer outlet in communication a marinade reservoir connected thereto for receiving marinade in a closed loop flow path. An electric motor has an output shaft connected to the marinade reservoir to rotate the marinating vessel. A peristaltic pump housed within the base is configured with an inlet in fluid communication with the marinade reservoir and a spray outlet disposed proximal the top of the rotating marinating vessel. A thermoelectric cooler is provided for cooling the marinade. The marinade spray outlet discharges a generally uniform spray of cooled marinade into a removable cup adapted for holding marinade ingredients such as lemons, spices, and the like. The cup includes a bottom defining an array of apertures for allowing the marinade to flow into the marinating vessel containing the food product.

Accordingly, it is an object of the present invention to provide an apparatus for automatically marinating foods.

Another object of the present invention is to provide an apparatus for automatically marinating foods using a closed loop marinade circulating circuit.

Still another object of the present invention is to provide an apparatus for automatically marinating foods using a closed loop marinade circuit having a peristaltic pump.

Yet another object of the present invention is to provide such an apparatus wherein the marinade is cooled using a thermo-electric cooler.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of an apparatus for automatically marinating foods in accordance with the present invention;

FIG. 2 is a front view thereof;

FIG. 3 is a rear perspective view thereof;

FIGS. 4 and 5 are partially exploded front views thereof;

FIG. 6 is a rear exploded view shown in partial section;

FIG. 7 is a detail view of peristaltic pump and thermo-electric cooler components;

FIG. 8 is a rear view shown in partial section;

FIGS. 9 and 10 are exploded perspective views shown in partial section;

FIG. 11 is a bottom perspective view of a removable cup;

FIG. 12 is a perspective detail view of the removable cup in relation to the marinade spray outlet;

FIG. 13 is a side perspective view of the top portion of the apparatus;

FIG. 14 is a bottom perspective view thereof;

FIG. 15 is an exploded perspective view of the apparatus; and

FIG. 16 illustrates the automatic marinating apparatus mounted in the door of a refrigerator.

### DETAILED DESCRIPTION OF THE INVENTION

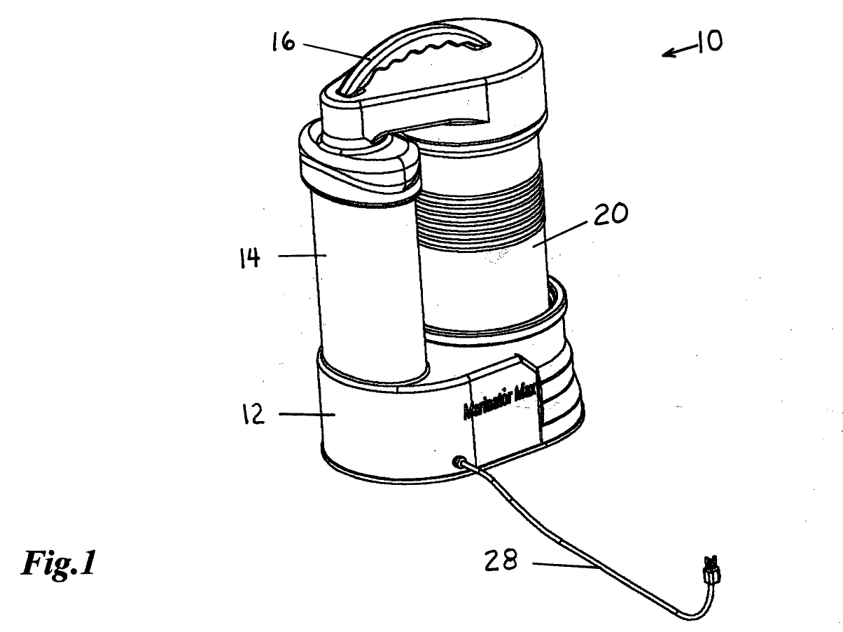

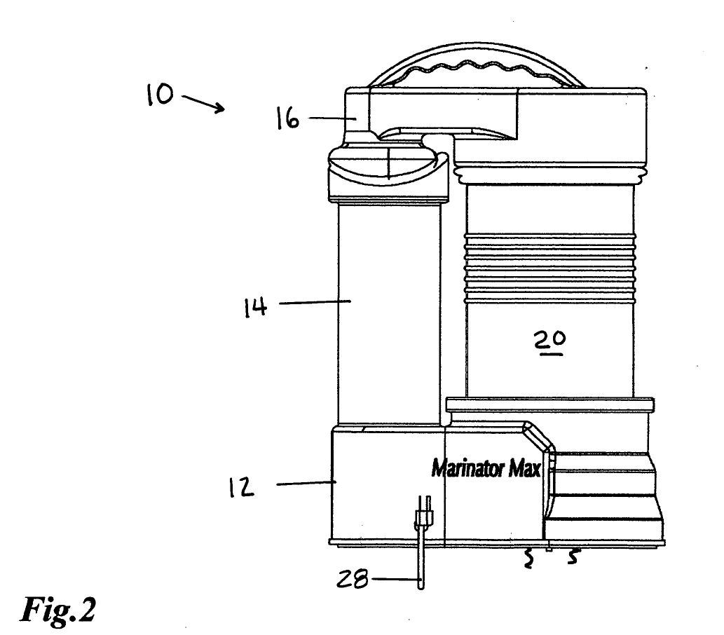

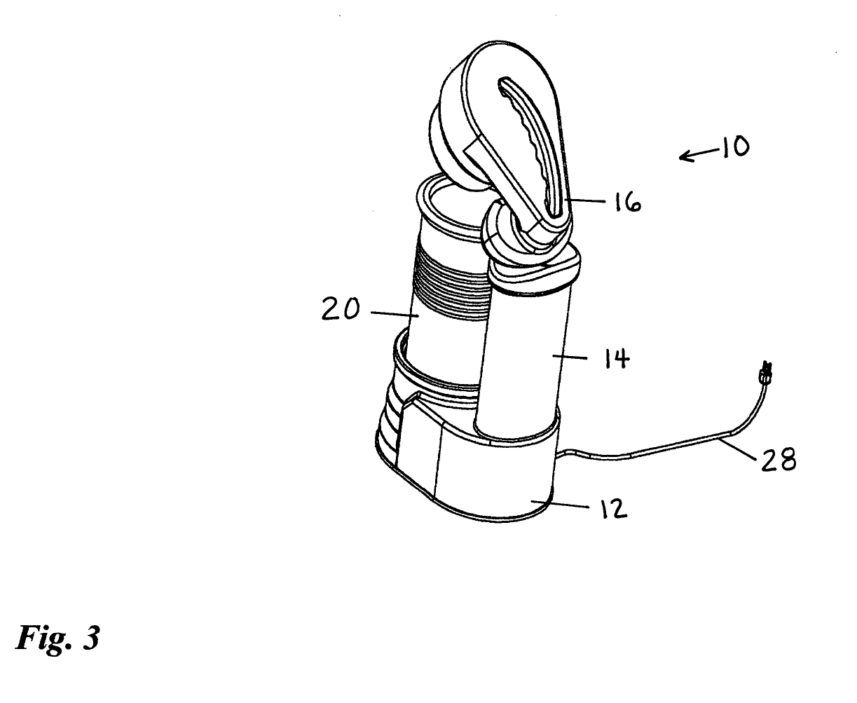

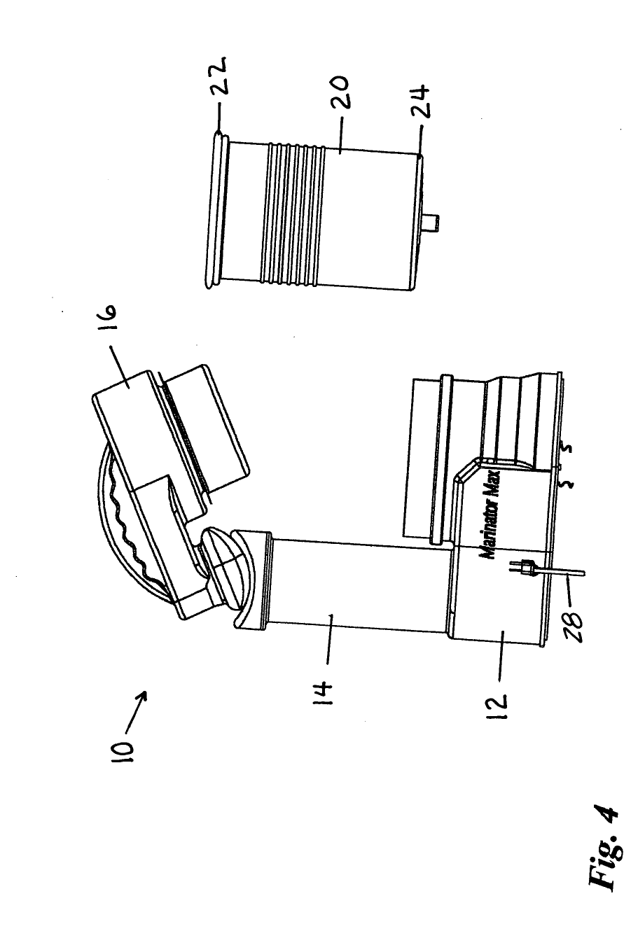

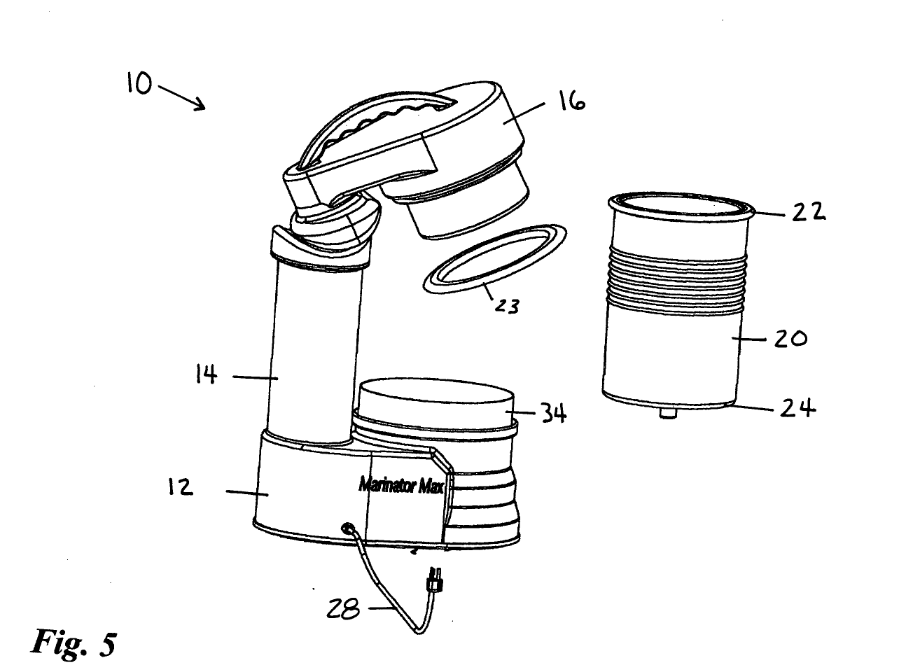

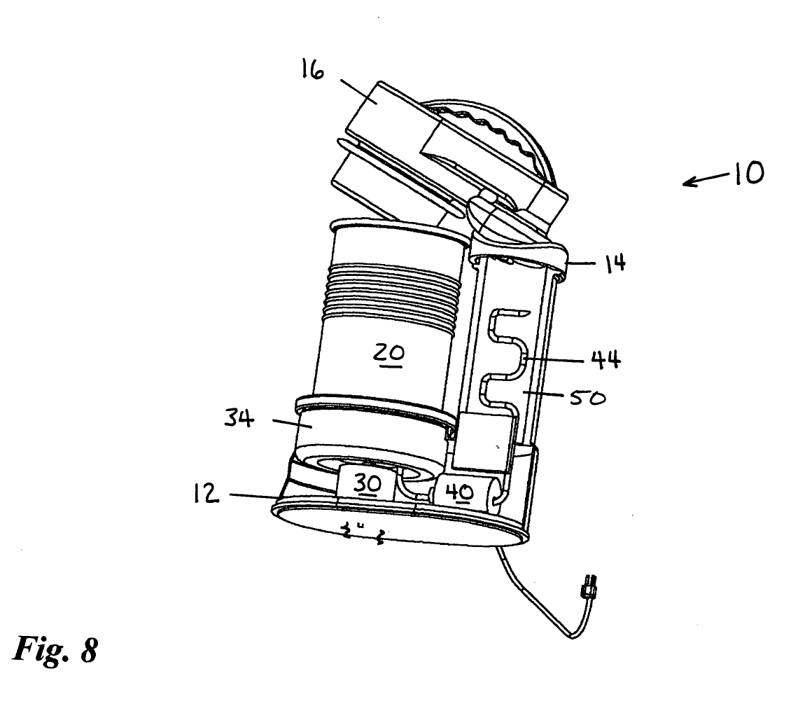

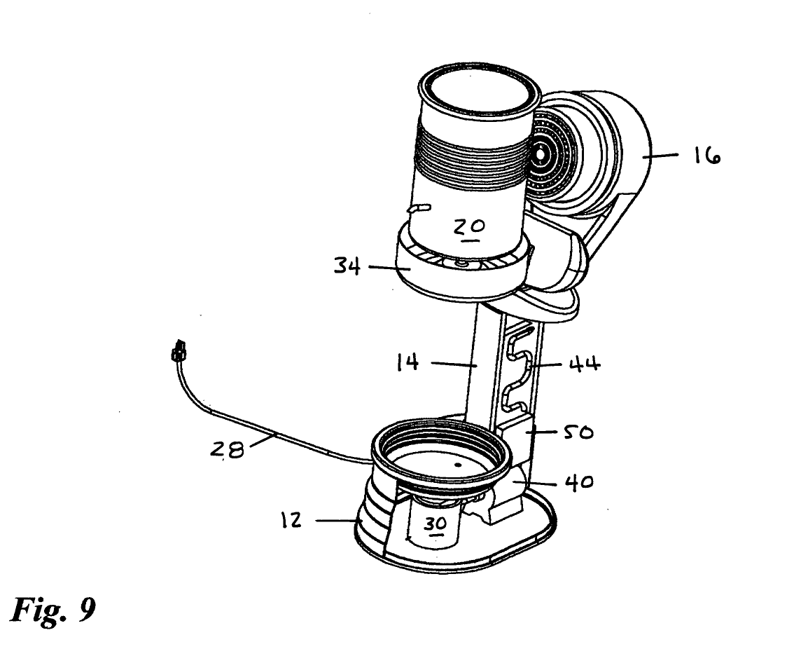

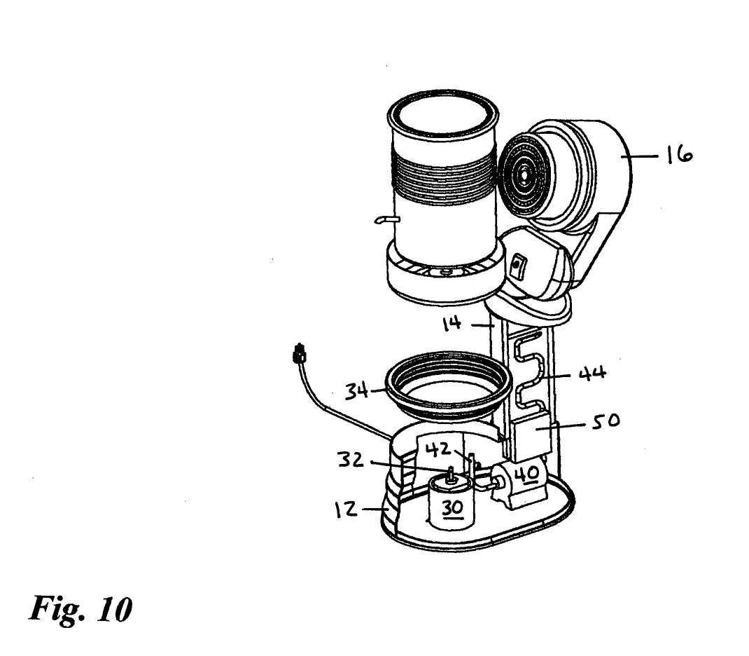

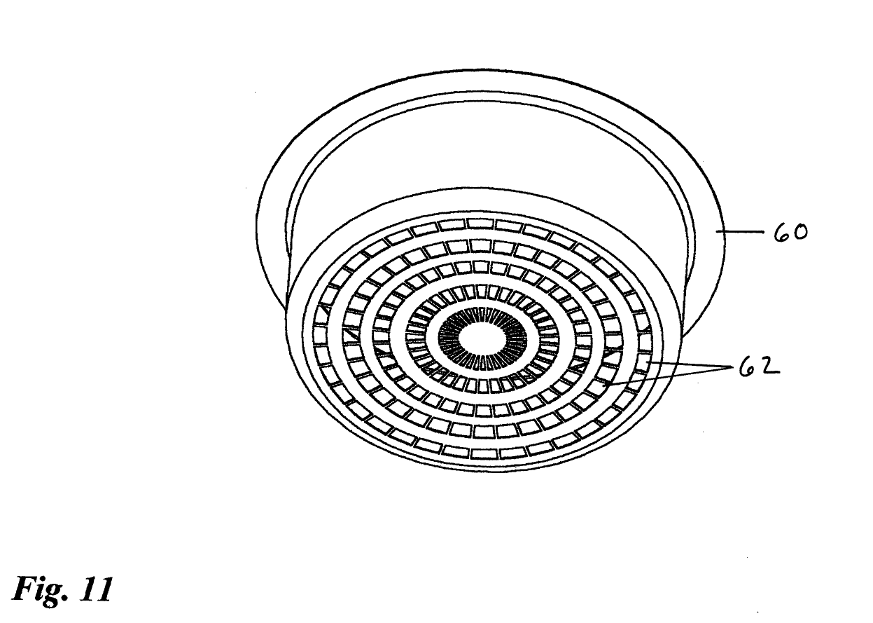

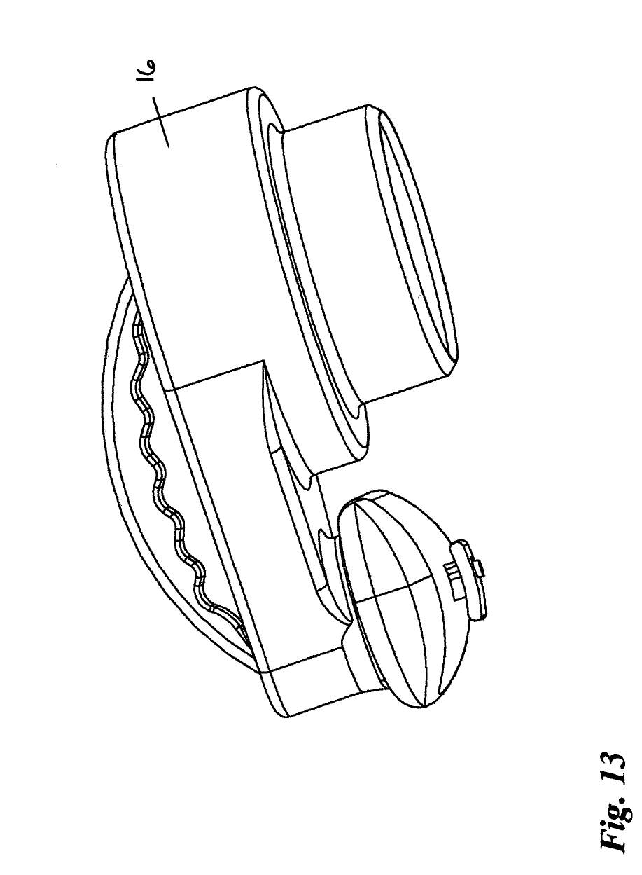

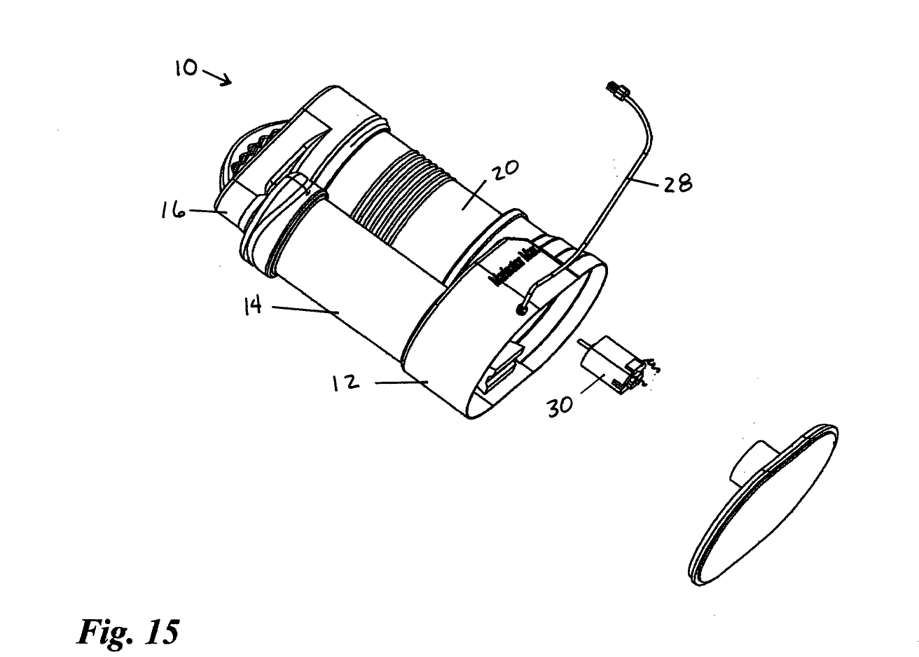

With reference now to the drawings, FIGS. 1-16 depict a preferred embodiment of an automatic marinating apparatus for foods, generally referenced as 10. More particularly, the present invention provides an electric food marinating apparatus capable of automatically marinating foods by circulating and chilling liquid marinade over food product, such as meat, in a closed loop circuit. Automatic food marinating apparatus 10 includes a base 12, a vertically projecting body 14, and a top 16 pivotally connected to body 14. Top 16 is pivotally connected to body 14 so as to allow for pivotal movement thereof from a closed configuration depicted in FIGS. 1 and 2, to an open configuration depicted in FIGS. 3 and 4. Base 12, body 14, top 16 are preferably fabricated from vacuum formed plastic to form generally hollow housings, however, any suitable material and manufacturing method is considered within the scope of the present invention.

A marinating vessel 20 is removably disposed between base 12 and top 16 as best depicted in FIGS. 1-4, and is mounted in a configuration that allows for rotation about a vertical axis relative to apparatus 10. Marinating vessel 20 comprises a generally hollow cylindrical container defining a generally open top and bottom portions, referenced as 22 and 24 respectively. Vessel 20 is preferably fabricated from stainless steel, however, any suitable material is considered within the scope of the present invention. Vessel 20 functions to contain food, such as meat, and a flow of marinade as further disclosed herein. An O-ring seal 23 may be used to provide a positive seal between the top 22 of vessel 20 and the top 16 of apparatus 10. Bottom 24 defines a structure, such as mesh, or an array of small apertures to prevent particles of a predetermined size from passing through.

Apparatus base 12 includes a substantially flat bottom for stable placement of apparatus 10 on a flat counter top. Base 12 and vertically projecting body 14 define generally hollow housings for containing mechanical and electrical components to facilitate automatic marinating of food contained within vessel 20. Accordingly, base 12 includes an electric motor 30 having a vertically upward projecting shaft 32 connected to an open topped, generally cylindrical, marinade reservoir 34 rotatably mounted within base 12 and adapted to receive the bottom 24 of marinating vessel 20 therein. Marinade reservoir 34 further includes an outlet 36 for allowing liquid marinade to flow therefrom. An electric power cord 28 provides electric power for motor 30 and the other electrical components discussed herein.

Base 12 further includes a peristaltic pump 40 having an inlet tube 42 in fluid communication with marinade reservoir outlet 36 for drawing liquid marinade from reservoir 34. A peristaltic pump is a type of positive displacement pump used for pumping a variety of specialized fluids. The fluid is contained in a flexible hose fitted inside a circular pump casing. A rotor with a number of cams attached to the external circumference compresses the flexible tube. As the rotor turns, the part of tube under compression rotates thus forcing the fluid to be pumped to move through the tube. A significant advantage is realized by the use of a peristaltic pump. Specifically, the since the only part of the pump in contact with the fluid being pumped is the interior of the tube, the marinade is not subject to contamination and it is easy to sterilize and clean the inside surfaces of the pump between uses by circulating water and a mild detergent through the pump.

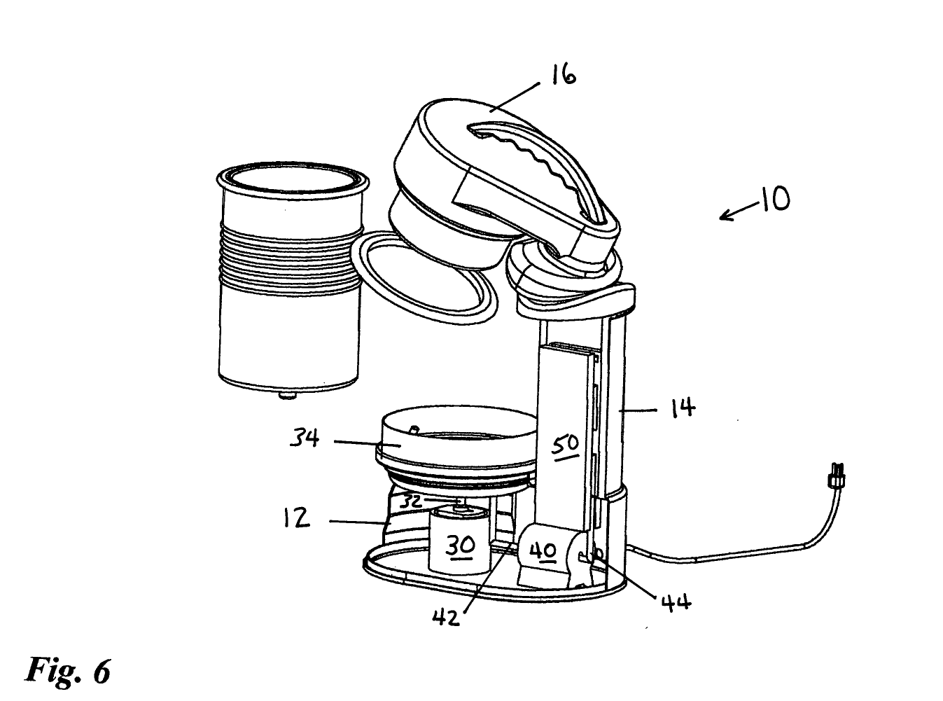

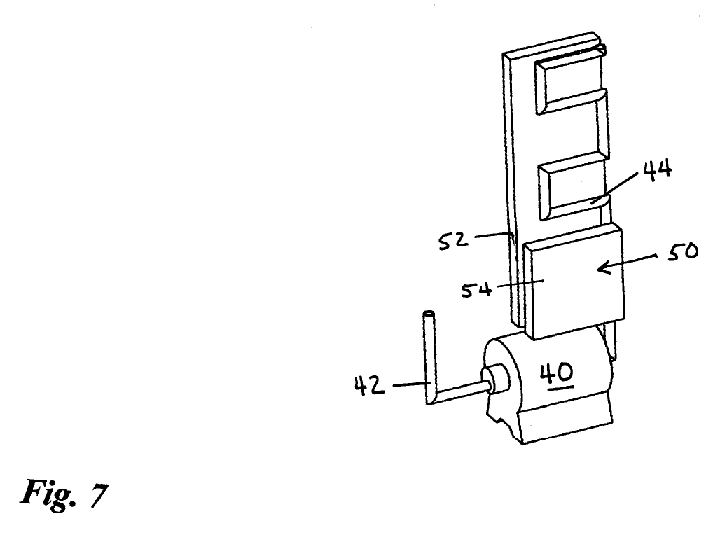

Another significant aspect of the present invention includes the use of a thermo-electric cooler, referenced as 50, housed within body 16 to chill the liquid marinade. As best depicted in FIGS. 6-8, pump 40 further includes an outlet tube 44 carrying the liquid marinade to thermo-electric cooler 50. Thermo-electric cooler 50 preferably includes opposing metal heat transfer plates 52 and 54 disposed in face-to-face relation with the liquid marinade outlet tube 44 disposed therebetween. Heat transfer if further maximized by routing liquid marinade outlet tube 44 in a serpentine path as best depicted in FIG. 7, so as to maximize heat transfer surface area and the time that the liquid marinade is in contact with heat transfer plates 52 and 54.

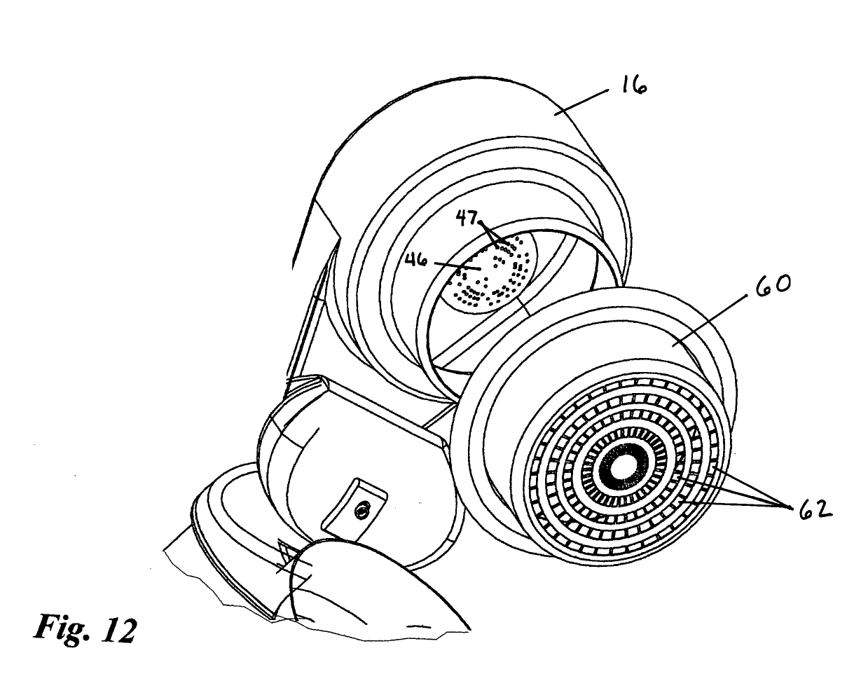

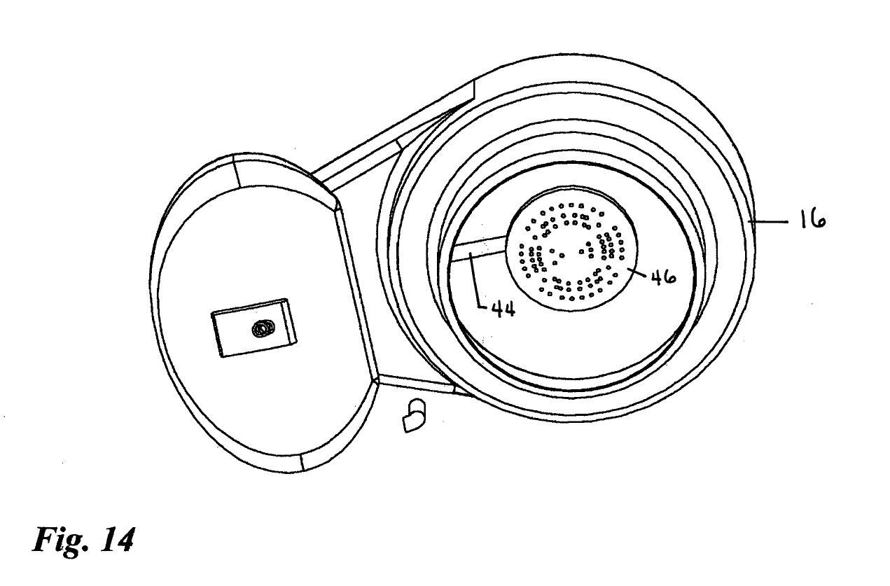

Tube 44 exits the thermo-electric cooler proximal top 16 and terminates in a spray outlet nozzle 46 as seen in FIGS. 12 and 14. Spray nozzle 46 is configured with an array of apertures 47 to produce multiple streams of liquid marinade. Marinade spray outlet nozzle 46 discharges a generally uniform spray of cooled marinade into a cup 60 removably connected to top 16 as best illustrated in FIG. 12. Cup 60 is preferably generally cylindrical and may be employed for holding larger marinade ingredients such as lemons, spices, and the like that would otherwise not flow through pump 40 and tubes 42 and 44 thereby increasing the variety of spices and flavors. Cup 60 includes a bottom defining an array of apertures 62 for allowing the marinade to flow into the marinating vessel 20 so as to flow over the food contained therein.

As should now be apparent, apparatus 10 provides an automatic marinating device that may be used by (1) filling vessel 20 with a food product for marinating; (2) attaching vessel 20 to marinade reservoir 34 on base 12; (3) adding a sufficient quantity of liquid marinade to vessel 20; (4) adding additional marinade ingredients to cup 62 and attaching same to top 16 of apparatus 10 (optional); (5) closing top 16; and (6) supplying power to the apparatus. Whereby, the electrical power is supplied to motor 30, pump 40, and thermo-electric cooler 50, thus causing rotation of vessel 20, and pumping of marinade through a closed circuit that includes a flow of marinade through vessel 20 and thermo-electric cooler 50.

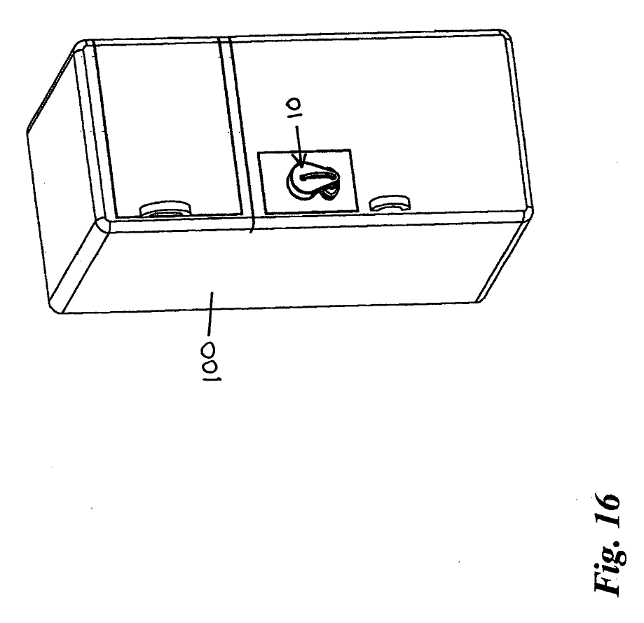

Finally, in a contemplated embodiment illustrated in FIG. 16 apparatus 10 may be installed as an accessory to a refrigerator, referenced as 100. In such an embodiment, the refrigerator may provide the cooling apparatus thus allowing for the elimination of thermo-electric cooler 50. In the alternative, the thermoelectric cooler may remain to enhance the chilling effect. Power may also be provided by the electrical system provided with the refrigerator.

The instant invention has been shown and described herein in what is considered to be the most practical and preferred embodiment. It is recognized, however, that departures may be made therefrom within the scope of the invention and that obvious modifications will occur to a person skilled in the art.

What we claim is:

1. A marinating apparatus for marinating food products, said marinating apparatus comprising:
a housing having a base;
a marinating vessel rotatably connected to said base, said marinating vessel having top and bottom openings, said bottom opening in fluid communication with a strainer;
said strainer in fluid communication with a marinade reservoir;
an electric motor having an output shaft configured to rotate said marinating vessel; and
means for pumping liquid marinade, said means for pumping including an inlet in fluid communication with said marinade reservoir, and an outlet in fluid communication with vessel top opening.

2. A marinating apparatus according to claim 1, further including means for chilling liquid marinade.

3. A marinating apparatus according to claim 1, wherein said means for pumping liquid marinade comprises a peristaltic pump.

4. A marinating apparatus according to claim 1, wherein said means for pumping outlet includes a spray attachment.

5. A marinating apparatus according to claim 1, further including a cup attachable to said housing top, said cup disposed between said means for pumping outlet and said vessel top opening, said cup including a bottom defining a plurality of apertures.

6. A marinating apparatus for marinating food products, said marinating apparatus comprising:
a housing having a base and a top pivotally connected to said base;
a marinating vessel rotatably connected to said base, said marinating vessel having top and bottom openings, said bottom opening in fluid communication with a strainer;
said strainer in fluid communication with a marinade reservoir;
an electric motor having an output shaft configured to rotate said marinating vessel; and
a peristaltic pump system having an inlet in fluid communication with said marinade reservoir, and an outlet in fluid communication with housing top, said outlet including a spay nozzle;
a cup removably attached to said housing top for receiving liquid marinade from said spray nozzle, said cup having an outlet in fluid communication with said marinating vessel top opening; and
a thermoelectric cooler in thermal contact with said peristaltic pump system for cooling liquid marinade flowing therein.
